(19) United States
(12) Patent Application Publication
(10) Pub. No.: US 2016/0154762 A1
(43) Pub. Date: Jun. 2, 2016

(54) ELETRONIC DEVICE AND ELECTRONIC DEVICE ASSEMBLY

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: XI-HUAI HE, Wuhan (CN); CHUN-SHENG CHEN, New Taipei (TW)

(21) Appl. No.: 14/587,362

(22) Filed: Dec. 31, 2014

(30) Foreign Application Priority Data
Nov. 28, 2014 (CN) 201410704257.5

(51) Int. Cl. G06F 13/42; G06F 13/40

(52) U.S. Cl. CPC G06F 13/4282; G06F 13/4045; G06F 13/4068

(57) ABSTRACT

An electronic device includes a system bus, an enhanced serial peripheral interface (e-SPI) bus, and a next generation form factor (NGFF) socket. The NGFF socket includes a plurality of functional pins and a plurality of pins which are reversed. The plurality of functional pins is coupled to the system bus and the plurality of reversed pins is coupled to the e-SPI bus.

### CROSS-REFERENCE TO RELATED APPLICATIONS

This Application claims priority to Chinese Patent Application No. 201410704257.5 filed on Nov. 28, 2014, the contents of which are incorporated by reference herein.

### FIELD

The subject matter herein generally relates to an electronic device with a debug port and an electronic device assembly.

### BACKGROUND

An electronic device needs to be tested for system compatibility and stability using a debug card before leaving the factory. A debug port is always defined in a motherboard of the electronic device.

### BRIEF DESCRIPTION OF THE DRAWINGS

Implementations of the present technology will now be described, by way of example only, with reference to the attached figures.

FIG. 1 is a diagrammatic view of an embodiment of an electronic device assembly.

FIG. 2 is a diagrammatic view of an M.2 socket of the electronic device assembly of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

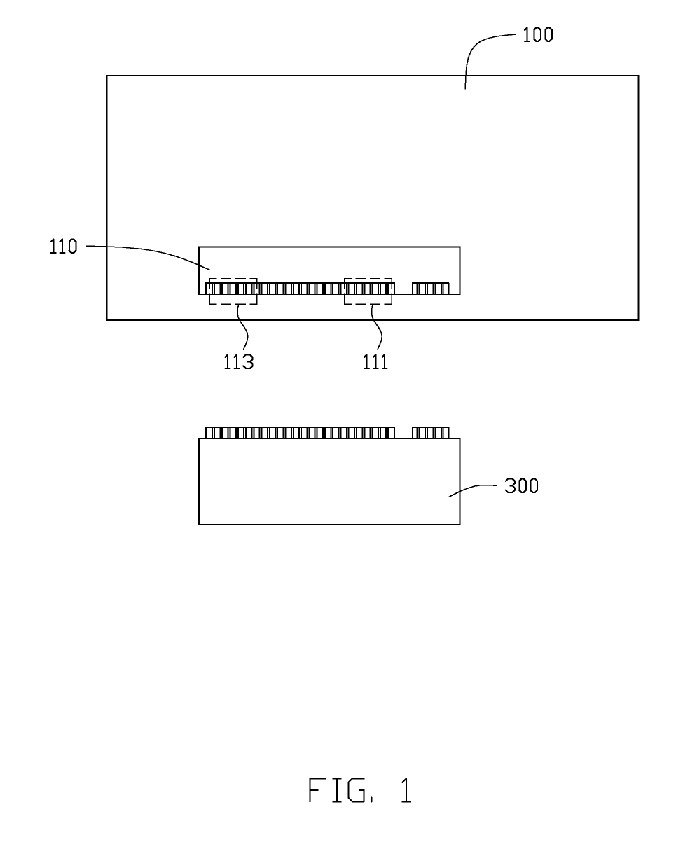

FIG. 1 illustrates an electronic device assembly in one embodiment. The electronic device assembly includes an electronic device and a debug card 300. The electronic device can be a server, a laptop computer, a desktop computer, a tablet computer, an all-in-one computer, a smart TV, or a set-box-top.

The electronic device includes a motherboard 100. The motherboard 100 defines at least one system bus and an enhanced serial peripheral interface (e-SPI) bus. The at least one system bus can include a serial advanced technology attachment (SATA) bus, a PCI-E bus, or an inter-integrated circuit (I2C) bus. An e-SPI bus is a successor to the Low Pin Count (LPC) bus developed by Intel™. The e-SPI bus can reduce the number of pins required on motherboards compared to systems using LPC. The e-SPI socket has more available throughput than the LPC socket. The working voltage of the e-SPI standard is reduced to 1.8 volts to facilitate smaller chip manufacturing processes.

The motherboard 100 includes a NGFF (Next Generation Form Factor) socket 110 which works as a debug port. The NGFF socket 110 is also named an M.2 socket. M.2 is a specification for internally mounted computer expansion cards and associated connectors. It replaces the Mini Serial Advanced Technology Attachment (mSATA) standard, which can use the Mini Peripheral Component Interconnect Express (PCI-E) card physical layout. M.2 is a more flexible physical specification that allows for modules of different widths and lengths, together with more advanced features, and the M.2 is more suitable for solid-state storage applications in general, especially when used in small devices like ultrabooks or tablets. The M.2 specification provides four PCI-E lanes and one SATA 3.0 port, exposed through the same connector, allowing use of both PCI-E and SATA storage devices in form of M.2 cards. Exposed PCI-E lanes provide a pure PCI-E connection to a storage device, without any additional layers of abstraction.

The M.2 socket 110 includes a plurality of functional pins 111 and a plurality of reversed pins 113. The plurality of functional pins 111 can be coupled to the system bus, such as SATA bus, PCI-E bus, or I2C bus.

The debug card 300 can diagnose system problems of the electronic device when coupled to the M.2 socket 110.

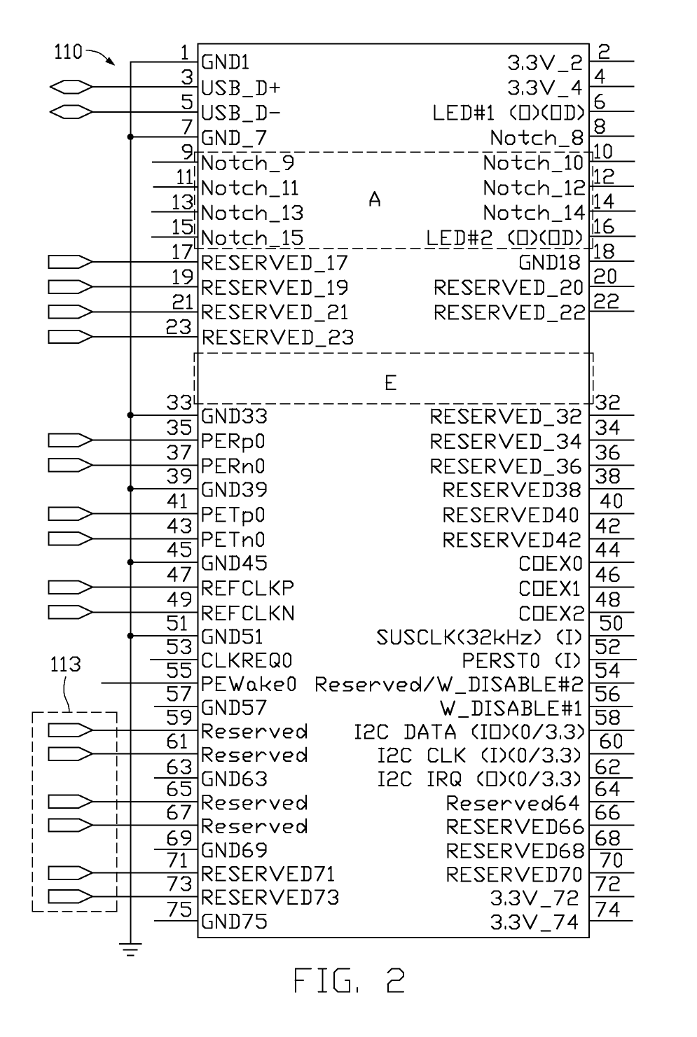

FIG. 2 is diagrammatic view of the M.2 socket 110 of FIG. 1. A model number of the M.2 socket 110 is 2230-S3-A-E. The M.2 socket 110 includes a plurality of pins 1-74. A plurality of pins numbered 59, 61, 65, 67, 71, and 73 is defined as reversed pins 113. The plurality of reversed pins is coupled to the e-SPI bus. A number of the plurality of reversed pins 113 is six. The pins 59 and 61 are a pair. The pins 65 and 67 are paired. The pins 71 and 73 are paired. A plurality of pins 8-15 in area A and a plurality of pins 24-31 can be defined as functional pins to couple with SATA bus, PCI-E bus, or I2C bus.

In other embodiments, the number of reversed pins can be seven, or nine for greater data exchanging speeds.

The embodiments shown and described above are only examples. Many details are often found in the art such as the other features of an electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An electronic device, comprising:
a system bus and an enhanced serial peripheral interface (e-SPI) bus; and
a next generation form factor (NGFF) socket comprising a plurality of functional pins and a plurality of reversed pins;
wherein the plurality of functional pins is coupled to the system bus; the plurality of reversed pins is coupled to the e-SPI bus.

2. The electronic device of claim 1, wherein the system bus comprises an aerial advanced technology attachment (SATA) bus, and the plurality of functional pins is coupled to the SATA bus.

3. The electronic device of claim 1, wherein the system bus comprises a peripheral component interconnect express (PCI-E) bus, and the plurality of functional pins is coupled to the PCI-E bus.

4. The electronic device of claim 1, wherein the system bus comprises an inter-integrated circuit (I2C) bus, and the plurality of functional pins is coupled to the I2C bus.

5. The electronic device of claim 1, wherein a number of the plurality of reversed pins is six.

6. The electronic device of claim 1, wherein a number of the plurality of reversed pins is nine.

7. The electronic device of claim 1, wherein a type of the NGFF socket is 2230-S3-A-E.

8. An electronic device, comprising:
an enhanced serial peripheral interface (e-SPI) bus; and
a next generation form factor (NGFF) socket acted as a debug port, the NGFF socket comprising a plurality of reversed pins;
wherein the plurality of reversed pins is coupled to the e-SPI bus.

9. The electronic device of claim 8, wherein a number of the plurality of reversed pins is six.

10. The electronic device of claim 8, wherein a number of the plurality of reversed pins is nine.

11. The electronic device of claim 8, wherein a model number of the NGFF socket is 2230-S3-A-E.

12. An electronic device assembly, comprising:
an electronic device comprising:
a system bus and an enhanced serial peripheral interface (e-SPI) bus; and
a next generation form factor (NGFF) socket comprising a plurality of functional pins and a plurality of reversed pins; and
a debug card configured to coupled to the NGFF socket for system debugging;
wherein the plurality of functional pins is coupled to the system bus; the plurality of reversed pins is coupled to the e-SPI bus.

13. The electronic device assembly of claim 12, wherein a number of the plurality of reversed pins is six.

14. The electronic device assembly of claim 12, wherein a number of the plurality of reversed pins is nine.

15. The electronic device assembly of claim 12, wherein a model number of the NGFF socket is 2230-S3-A-E.
